(19) United States
(12) Patent Application Publication
(10) Pub. No.: US 2017/0006201 A1
(43) Pub. Date: Jan. 5, 2017

(54) ENDOSCOPE AND METHOD FOR USING SAME

(71) Applicant: TURBOMECA, Bordes (FR)

(72) Inventors: Frédéric Segura, Lescar (FR); Francis CAETANO, Arudy (FR); Thibault ELGOYHEN, St Faust (FR); Ludovic MEZIERE, Cauterets (FR)

(73) Assignee: TURBOMECA, Bordes (FR)

(21) Appl. No.: 15/105,497

(22) PCT Filed: Dec. 10, 2014
(86) PCT No.: PCT/FR2014/053249

§ 371 Date: Jun. 16, 2016

(30) Foreign Application Priority Data
Dec. 20, 2013 (FR) 1363338

(51) Int. Cl. H04N 5/225; H04N 7/22; H04N 5/232

(52) U.S. Cl. CPC H04N 5/2256; H04N 5/23293; H04N 7/22; H04N 2005/2255

(57) ABSTRACT

The invention relates to the field of inspecting mechanical parts, and in particular to an endoscope (1) suitable for being used for frequency inspection of a part that is difficult to access, and also to a method of using the endoscope (1), which endoscope comprises an endoscopic head (2), an image display device (3) for displaying images picked up via said endoscopic head (2), and an elongate member (4) connecting the endoscopic head (2) to the display device (3), and in which the endoscopic head (2) also includes a frequency inspection device (7) comprising at least one vibration sensor (10) for picking up a vibratory response of a subject for frequency inspection.

### BACKGROUND OF THE INVENTION

The present invention relates to the field of inspecting mechanical parts, and in particular inspecting mechanical parts that are difficult to access.

The person skilled in the art knows that endoscopes can be used for visually inspecting mechanical parts that are difficult to access. An endoscope, of the kind used in mechanical engineering, in building, and also in medicine, typically comprises an endoscopic head, a device for displaying images that have been picked up by means of said endoscopic head, and an elongate member connected to the endoscopic head. Thus, the endoscopic head can be inserted through a narrow orifice, and the elongate member can be used to guide it towards a subject for inspection in order to proceed with visual inspection via the endoscopic head and the display device. Such endoscopes include rigid endoscopes and also endoscopes that are flexible in order to be capable of going round obstacles on the path followed by the endoscopic head. Furthermore, optical endoscopes are also known in which the endoscopic head is connected to the display device by at least one optical fiber directly transmitting the light picked up by the endoscopic head, as are video endoscopes in which the endoscopic head has a video sensor connected in wired or wireless manner to the display device. Such an endoscope is normally also provided with a lighting device, either directly on the endoscopic head, or else connected thereto by at least one optical fiber, thus enabling subjects for inspection to be lighted to enable them to be inspected visually.

Nevertheless, in some circumstances, mere visual inspection is not sufficient in order to determine the integrity state of a mechanical part. Thus, certain defects that are hidden from mere visual inspection can be detected by frequency inspection, also referred to as a “ping” test. With such frequency inspection, the subject for inspection is subjected to at least one tap in order to trigger vibration, and analyzing the frequencies of the vibratory mechanical response can make it possible to detect potential defects in the subject for inspection or merely to characterize the subject for inspection. In its simplest version, an inspector lightly taps the subject for inspection and listens to the sound it gives off in response.

Nevertheless, in the state of the art, in order to perform such frequency inspection on a part that is difficult to access, it is often necessary to dismantle it, which can be very expensive in terms of time and manpower. Also, frequency inspection that is performed on a part that has been dismantled can be un-representative.

### OBJECT AND SUMMARY OF THE INVENTION

The present invention seeks to remedy those drawbacks. In particular, the present disclosure seeks to propose an endoscope that makes it possible to perform not only visual inspection, but also frequency inspection of a part that is difficult to access.

In at least one embodiment, this object is achieved by the fact that the endoscopic head of the endoscope includes a frequency inspection device comprising at least one vibration sensor, a contact element for mechanically exciting a subject for frequency inspection, and an actuator for tapping said contact element against the subject for frequency inspection.

By means of these provisions, the endoscopic head can be guided visually to a subject for frequency inspection that is difficult to access in order to bring this part into range of the vibration sensor and the contact element so as to be able to perform frequency inspection of the subject.

In particular, the frequency inspection device may comprise at least one electromechanical microsystem, including the vibration sensor and/or at least the actuator of the contact element for mechanically exciting the subject for frequency inspection, thus making it possible to limit the space occupied by the endoscopic head so as to enable it to access locations that are particularly inaccessible.

In order to enable the vibratory response of the subject for inspection to be picked up in particularly accurate manner, the vibration sensor may in particular be a microphone.

In order to make it possible to go round obstacles on the path of the endoscopic head, the endoscope may be a flexible endoscope, i.e. an endoscope in which the elongate member can bend, e.g. through at least 30°. Alternatively, it is nevertheless possible for the endoscope to be a rigid endoscope, i.e. an endoscope in which the elongate member cannot bend in this way.

The endoscope may be an optical endoscope, i.e. an endoscope in which the endoscopic head is connected to the image display device via at least one optical fiber. Alternatively, it is nevertheless possible for the endoscope to be a video endoscope, i.e. an endoscope in which the endoscopic head has a video sensor connected to the image display device.

Naturally, the endoscope may further include a lighting device. In particular, the lighting device may be mounted directly on the endoscopic head, or it may be connected thereto via at least one optical fiber.

Furthermore, the actuator may be distinct from the vibration sensor, however it may also be combined therewith, particularly if the actuator is a piezoelectric, magnetic, or electromechanical actuator. Furthermore, other types of actuator, in particular pneumatic actuators and resilient springs may equally well be envisaged for driving the striker. The actuator may be configured to cause the contact element to give the subject for inspection a single tap, so as to give rise to the vibratory response of the subject by a single impact, or else to cause the contact element to vibrate, thereby enabling the response of the subject for frequency inspection to be analyzed at at least one predetermined excitation frequency.

As an alternative to incorporating the contact element and the actuator in the same endoscopic head as the vibration sensor, the present disclosure also provides a set comprising a first endoscope with an endoscopic head having a frequency inspection device with a vibration sensor, an image display device for displaying images picked up via the endoscopic head, and an elongate member connected to the endoscopic head, together with a second endoscope comprising an endoscopic head with at least one contact element for mechanically exciting the subject for frequency inspection, an actuator for tapping the contact element against the subject for frequency inspection, an image display device for displaying images picked up via the endoscopic head of the second endoscope, and an elongate member connected to the endoscopic head of said second endoscope. A single device may possibly be used for displaying images from the first and second endoscopes, so as to share resources, and the first and second endoscopes may equally well be optical or video endoscopes, and they may be flexible or rigid. All of the above-mentioned types of actuator can likewise be used in this alternative.

The invention also provides a method of using the endoscope for frequency inspection of a subject for inspection. In at least one implementation, this method may comprise causing the endoscope to approach the subject for inspection in guided manner, exciting the subject for inspection by using the actuator to tap the contact element against the subject for inspection so as to cause a vibratory response, and receiving said vibratory response via the vibration sensor. The vibratory response picked up by the vibration sensor may then be subjected in particular to frequency analysis in order to determine the integrity state of the subject for inspection.

### BRIEF DESCRIPTION OF THE DRAWINGS

The invention can be well understood and its advantages appear better on reading the following detailed description of several embodiments shown as nonlimiting examples. The description refers to the accompanying drawings, in which:

FIG. 1A is a diagram showing an endoscope in a first embodiment;

FIG. 1B is a detail view of the endoscopic head of the FIG. 1A endoscope;

FIGS. 2A to 2C are diagrams showing ways of using the FIG. 1A endoscope for inspecting different parts of a turbine engine;

FIG. 3 is a diagram showing the endoscopic head of an endoscope in a second embodiment;

FIG. 4 is a diagram showing the endoscopic head of an endoscope in a third embodiment;

FIG. 5 is a diagram showing the endoscopic head of an endoscope in a fourth embodiment; and

FIG. 6 is a diagram showing a set comprising first and second endoscopes in a sixth embodiment.

### DETAILED DESCRIPTION OF THE INVENTION

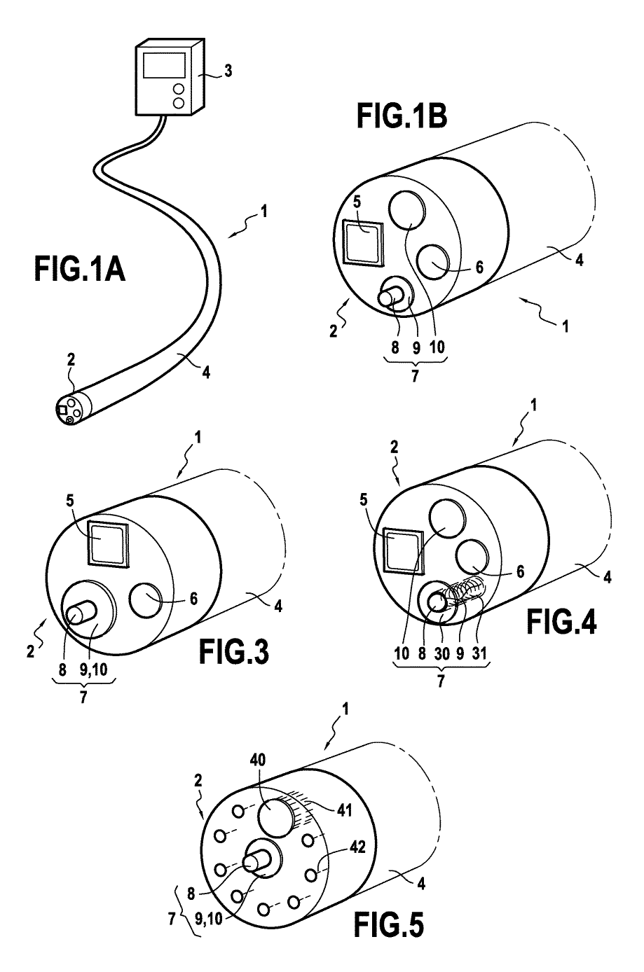

An endoscope 1 in a first embodiment is shown in FIGS. 1A and 1B. This endoscope 1 comprises an endoscopic head 2, a display device 3, and an elongate member 4 in the form of a rod connecting the endoscopic head 2 to the display device 3 and enabling the endoscopic head 2 to be inserted in confined spaces while displaying images picked up by the endoscopic head 2 to a user on the outside by means of the display device 3. In the embodiment shown, the elongate member 4 is flexible, being capable of bending between its two ends through at least 30°, and possibly through at least 90°, so as to be capable of moving past obstacles on the path of the endoscopic head 2. In alternative embodiments, the elongate member could, nevertheless, be substantially rigid.

FIG. 1B shows a detail view of the endoscopic head 2 of the endoscope 1 in this first embodiment. Thus, the endoscope 1 in this first embodiment is a video endoscope, and there can thus be seen on the endoscopic head 2 a video sensor 5, which may for example be a charge-coupled device (CCD) type sensor or a complementary metal oxide semiconductor (CMOS) type sensor, a lighting device 6, which may by way of example be a light-emitting diode (LED), and a frequency inspection device 7 comprising a contact element 8, an actuator 9 suitable for tapping the contact element 8 against a subject for frequency inspection, and a vibration sensor 10 suitable for picking up vibration from the subject for frequency inspection in response to it being mechanically excited by the contact element 8. The actuator 9 may be configured to cause the contact element 8 to tap the subject for inspection on a single occasion, so as to excite vibration therein by a single impact, or else to set it into vibration against the subject for inspection. The material of the contact element 8 may be selected as a function of how it is used. Thus, for example, if the frequency inspection device 7 is configured to excite the vibratory response of the subject for inspection by a single impact, then the contact element 8 may be made of a material that is comparatively hard, such as a ceramic or a metal material. However, if the contact element 8 is to transmit vibration from the actuator 9 to the subject for frequency inspection, then it is possible to use a softer material for this contact element 8, such as an elastomer or some other synthetic polymer, in particular.

In this first embodiment, the actuator 9 and the vibration sensor 10 are two distinct electromechanical microsystems. By way of example, the actuator 9 may be piezoelectric, electrostatic, or electromagnetic, while the vibration sensor 10 is a microphone that may likewise be piezoelectric, electrostatic, or electromagnetic, for example. Alternatively, the actuator 9 may nevertheless be a pneumatic actuator, while the vibration sensor 10 may be some other type of vibration sensor with or without contact, such as for example a laser vibrometer or accelerometer, or an optical fiber microphone.

The video sensor 5 is connected to the display device 3 via the elongate member 4, and the actuator 9 and the vibration sensor 10 may also be connected via the elongate member 4 respectively to a control device (not shown) and to a signal analysis device (not shown) so as to be able to trigger a tap of the contact element 8 against the subject for frequency inspection and then be able to analyze the vibration of the subject for frequency inspection in response to being tapped in order to evaluate its integrity. These connections may be wired connections, e.g. electrical or by optical fiber, or else they may be wireless connections, e.g. via radio or ultrasound transponders.

Thus, while it is in use, the endoscopic head 2 may be inserted into a confined space that is difficult to access, and it can be visually guided up to the subject that is to be frequency inspected by using the images picked up by the video sensor 5 with the light from the lighting device 6. In the proximity of said subject for frequency inspection, the actuator 9 can be activated in order to tap the contact element 8 against the subject for frequency inspection. Vibration is triggered in the subject for frequency inspection by this tap, and the vibration is picked up by the sensor 10, possibly for transmitting via the elongate member 4 for analysis in order to determine the integrity of the subject for frequency inspection.

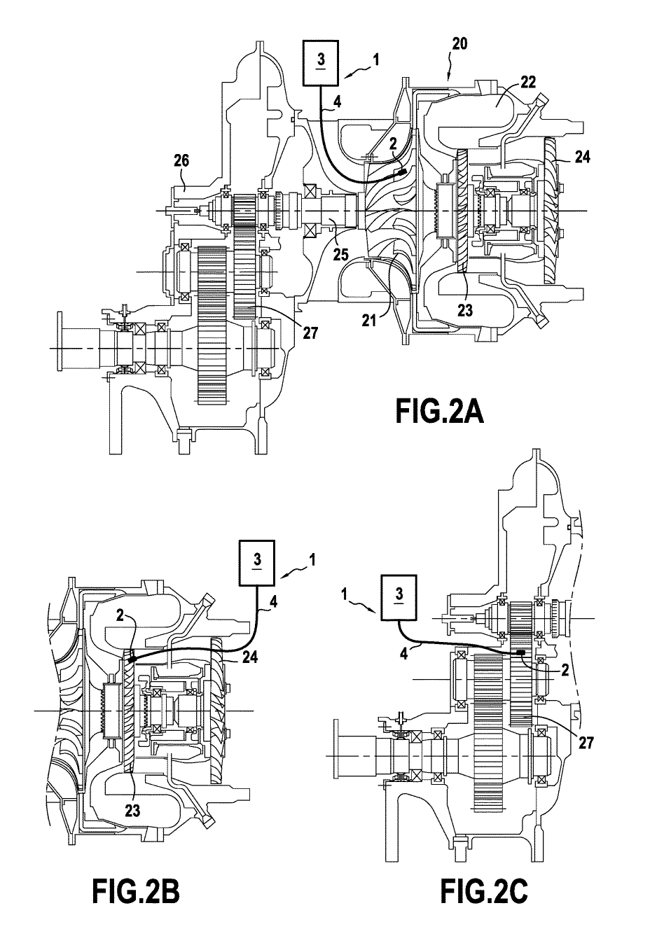

FIGS. 2A to 2C show example applications of the endoscope and the frequency inspection method for inspecting parts in a turbine engine that are difficult to access, and more particularly a turbine engine 20 comprising a centrifugal compressor 21, a combustion chamber 22, a high-pressure axial turbine 23 constrained to rotate with the compressor 21, a low-pressure axial turbine 24, a power outlet shaft 25 constrained to rotate with the low-pressure axial turbine 24, and a gearbox 26 connected to the power outlet shaft 25 and comprising a run of meshing gearwheels 27.

In FIG. 2A, the endoscope 1 can thus be seen in use for visual and frequency inspection of blades of the centrifugal compressor 21. To do this, the endoscopic head is inserted through the air intake of the engine 20 and guided to the centrifugal compressor 21. In addition to visually inspecting the blades of the compressor 21 by means of the display device 3 of the endoscope 1, the user can also perform frequency inspection by activating the actuator 9 in order to tap the contact element 8 against each blade, thereby triggering vibration that is picked up by the vibration sensor 10 for possible subsequent analysis in order to detect defects that cannot be detected merely by visual inspection.

In FIG. 2B, the endoscope 1 can be seen in use for visual and frequency inspection of blades of the high-pressure axial turbine 23. To do this, the endoscopic head 2 is inserted through the exhaust of the engine 20 and through its low-pressure axial turbine 24 to the high-pressure axial turbine 23. The blades of the low-pressure axial turbine 24 can thus be subjected to visual and frequency inspection in a manner analogous to the inspection of the blades of the compressor 21 as shown in FIG. 2A.

In FIG. 2C, the endoscope 1 can be seen in use for performing visual and frequency inspection of a gearwheel 27 of the gearbox 26. In this example, after opening an inspection hatch 28 in the gearbox 26, the endoscopic head 2 is inserted therein in order to perform visual and frequency inspection of the gearwheel 27, under real meshing conditions, and in a manner analogous to the inspections of the blades shown in FIGS. 2A and 2B.

Alternative embodiments can also be envisaged for the endoscope. Thus, in FIG. 3, there can be seen the endoscopic head 2 of an endoscope 1 in a second embodiment, in which the actuator 9 and the vibration sensor 10 are incorporated in a single electromechanical microsystem. Thus, the piezoelectric, electromagnetic, or electrostatic element for tapping the contact element 8 against the subject for frequency inspection is also used subsequently for picking up the vibratory response of the subject for frequency inspection. The remaining elements of this endoscope 1 are equivalent to those of the first embodiment and they are given the same numerical references.

In both of the above embodiments, the contact element is secured to its actuator, thereby limiting its range. In the third embodiment shown in FIG. 4, the contact element 8 is in the form of a bead, that is held in the endoscopic head 2 against the action of a spring constituting the actuator 9 by means of an electromagnet 30. Deactivating the electromagnet 30 thus causes the contact element 8 to be tapped against the inspected subject, which it strikes in such a manner as to give rise to its vibratory response merely by percussion or impact. Other types of actuator, e.g. such as pneumatic or magnetic actuators could nevertheless also be envisaged as an alternative thereto. Even though it can move away from the endoscopic head 2, the contact element 8 nevertheless remains attached thereto by a leash 31, thus avoiding contaminating the space in which the inspection is performed. The other elements of the endoscope 1 are equivalent to those of the first embodiment, and consequently they are given the same numerical references.

In all three of the above embodiments, the endoscope 1 is a video endoscope. Nevertheless, it is also possible to envisage applying the same principles to an optical endoscope, such as that of the fourth embodiment, having its endoscopic head 2 shown in FIG. 5. Thus, this endoscopic head 2 no longer has a video sensor, but rather an optical lens 40 that is connected to a display device at the other end of the elongate member 4 by optical fibers 41. The display device could thus be a simple optical eyepiece. Furthermore, in order to further limit the overall size and the complexity of the endoscopic head 2, the lighting device is no longer mounted thereon, but is mounted at the other end of the elongate member 4, and the elongate member also contains other optical fibers 42 for transmitting the light emitted by the lighting device to the endoscopic head. The other elements of this endoscope 1 are equivalent to those of the second embodiment, and consequently they are given the same numerical references.

Furthermore, it is not essential for the endoscope to be flexible.

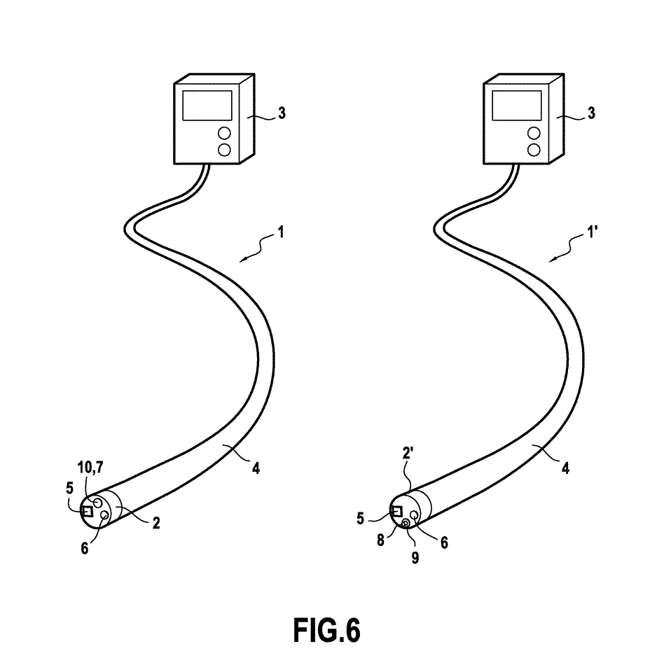

Nor is it essential for the means that are to give rise to the vibratory response to be installed on the same endoscopic head as the vibration sensor that is to pick up the response. Thus, in a sixth embodiment shown in FIG. 6, use is made of a set of two endoscopes 1 and 1′. The first endoscope 1 is analogous to the endoscope of the first embodiment except that its endoscopic head 2 does not have the contact element 8 or the actuator 9. Specifically, these elements are fitted to the endoscopic head 2′ of the second endoscope 1′, that is likewise analogous to the endoscope of the first embodiment, except for the absence of a vibration sensor. It is thus possible, by means of this set, to trigger vibration in the subject for frequent inspection at one location using the second endoscope 1′, and to pick up the vibration at another location, using the first endoscope 1. The remaining elements of the first and second endoscopes 1, 1′ are equivalent to those of the endoscope 1 of the first embodiment and consequently they are given the same reference numbers.

Although the present invention is described with reference to specific embodiments, it is clear that various modifications and changes may be made to these embodiments without going beyond the general ambit of the invention as defined by the claims. Also, individual characteristics of the various embodiments mentioned may be combined in additional embodiments. In particular, even though both of the endoscopes in the set of the sixth embodiment are analogous to the endoscope of the first embodiment, each of them could also incorporate characteristics of other embodiments as an alternative or in addition to those shown. Consequently, the description and the drawings should be considered in a sense that is illustrative rather than restrictive.

1. An endoscope comprising:
an endoscopic head;
an image display device for displaying images picked up via said endoscopic head; and
an elongate member connected to the endoscopic head;
wherein said endoscopic head also includes a frequency inspection device comprising at least one vibration sensor, a contact element for mechanically exciting a subject for frequency inspection, and an actuator for driving said contact element against the subject for inspection.

2. The endoscope according to claim 1, wherein said frequency inspection device comprises at least one electromechanical microsystem.

3. The endoscope according to claim 1, wherein said vibration sensor is a microphone.

4. The endoscope according to claim 1, wherein said elongate member can bend through at least 30°.

5. The endoscope according to claim 1, wherein said endoscopic head is connected to the image display device via at least one optical fiber.

6. The endoscope according to claim 1, wherein said endoscopic head includes a video sensor connected to the image display device.

7. The endoscope according to claim 1, further including a lighting device.

8. The endoscope according to claim 1, wherein said actuator is piezoelectric.

9. A set comprising:
a first endoscope comprising:
an endoscopic head with a frequency inspection device including at least one vibration sensor;
an image display device for displaying images picked up via said endoscopic head; and
an elongate member connected to the endoscopic head; and
a second endoscope comprising:
an endoscopic head with at least one contact element for mechanically exciting a subject for frequency inspection and an actuator for driving said contact element against the subject for frequency inspection;
an image display device for displaying images picked up via the endoscopic head of said second endoscope; and
an elongate member connected to the endoscopic head of said second endoscope.

10. A method of using an endoscope for frequency inspection of a subject for inspection, wherein the endoscope comprises:
an endoscopic head including a frequency inspection device comprising at least one vibration sensor, a contact element for mechanically exciting a subject for inspection, and an actuator for driving said contact element against the subject for inspection;
an image display device for displaying images picked up via said endoscopic head; and
an elongate member connected to the endoscopic head;
the method comprising the following steps:
causing the endoscopic head to approach the subject for inspection in guided manner;
mechanically exciting the subject for inspection by driving the contact element by means of the actuator against the subject for inspection in order to give rise to a vibratory response; and
receiving said vibratory response via the vibration sensor.

11. A method of using a set for frequency inspection of a subject for inspection, the set comprising:
a first endoscope comprising:
an endoscopic head with a frequency inspection device including at least one vibration sensor;
an image display device for displaying images picked up via said endoscopic head; and
an elongate member connected to the endoscopic head; and
a second endoscope comprising:
an endoscopic head with at least one contact element for mechanically exciting the subject for inspection and an actuator for driving said contact element against the subject for inspection;
an image display device for displaying images picked up via the endoscopic head of said second endoscope; and
an elongate member connected to the endoscopic head of said second endoscope;
the method comprising the following steps:
causing the endoscopic heads to approach the subject for inspection in guided manner;
mechanically exciting the subject for inspection by driving the contact element by means of the actuator against the subject for inspection in order to give rise to a vibratory response; and
receiving said vibratory response via the vibration sensor.
